(19) United States
(12) Patent Application Publication
(10) Pub. No.: US 2025/0132829 A1
(43) Pub. Date: Apr. 24, 2025

(54) OPTICAL POWER CONTROL DEVICE, OPTICAL POWER CONTROL METHOD, AND OPTICAL TRANSMISSION SYSTEM

(71) Applicant: Fujitsu Limited, Kawasaki-shi (JP)

(72) Inventors: Kyosuke SONE, Kawasaki (JP); Tokuharu KIMURA, Isehara (JP); Tomohiro YAMAUCHI, Kawasaki (JP); Ryu SHINZAKI, Ota (JP); Shun OKADA, Kawasaki (JP); Motohiko ETO, Kawasaki (JP); Shoichiro ODA, Fuchu (JP)

(73) Assignee: Fujitsu Limited, Kawasaki-shi (JP)

(21) Appl. No.: 18/909,591

(22) Filed: Oct. 8, 2024

(30) Foreign Application Priority Data
Oct. 23, 2023 (JP) 2023-182155
Jun. 12, 2024 (JP) 2024-095488

(51) Int. Cl. H04B 10/079; H04B 10/2543; H04J 14/02

(52) U.S. Cl. CPC H04B 10/07953; H04B 10/2543; H04J 14/02

(57) ABSTRACT

An optical power control device includes a controller configured to: obtain a received waveform of a WDM optical signal transmitted between a plurality of transmission devices via a transmission path, and calculate a power profile of a distance direction of the transmission path based on the received waveform; and calculate a nonlinear SNR of the transmission path based on the power profile.

### CROSS REFERENCE TO RELATED APPLICATIONS

This application is based upon and claims the benefit of priority of the prior Japanese Patent Application No. 2023-182155, filed on Oct. 23, 2023, and the prior Japanese Patent Application No. 2024-095488, filed on Jun. 12, 2024, the entire contents of which are incorporated herein by reference.

### FIELD OF THE INVENTION

The embodiments discussed herein relate to an optical power control device, an optical power control method, and an optical transmission system.

### BACKGROUND OF THE INVENTION

To provide high-capacity optical communication, wavelength division multiplexing (WDM) has been put into practical use. The WDM enables large-capacity optical communication by transmitting optical signals using multiple wavelength channels and multiplexing a large number of wavelength channels.

Transmission characteristics of WDM signals are dependent on wavelength. When the transmission characteristics vary due to wavelength, the transmission distance and the number of wavelengths become limited, so conventionally, design and adjustment to suppress variation in optical power and optical signal-to-noise ratio (OSNR) has been performed.

Further, in recent years, bandwidth has been expanded in WDM transmission systems, for example, multiband (C+L band) WDM transmission systems that transmit optical signals using C band and L band simultaneously have been proposed. When the wavelength band for transmission is further expanded from only C band to C+L band, wavelength characteristics of GSNR of nonlinear noise+OSNR may not be uniform even when variation due to the wavelength of OSNR is suppressed. GSNR is an abbreviation of generalized SNR.

Prior techniques for optical power control that improve the transmission characteristics of optical signals include the following. For example, according to one technique, in an optical amplifier integrated with Raman amplifiers, operation of each Raman amplifier is adjusted based on information related to the OSNR of each Raman pump power and optical amplification, whereby deterioration of OSNR of output optical signals is prevented (for example, refer to International Publication No. WO 2002/021203). Further, according to another technique, in an optical amplifier integrated with Raman amplifiers, power deviation for each channel is determined by performing pre-emphasis of a transmitting power profile based on a function of nonlinear phase shift deviation and OSNR deviation of each span (for example, refer to U.S. Patent Application Publication No. 2014/0147113).

### SUMMARY OF THE INVENTION

According to an aspect of an embodiment, an optical power control device includes a controller configured to: obtain a received waveform of a WDM optical signal transmitted between a plurality of transmission devices via a transmission path, and calculate a power profile of a distance direction of the transmission path based on the received waveform; and calculate a nonlinear SNR of the transmission path based on the power profile.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an optical transmission system that includes an optical power control device according to an embodiment.

FIG. 2A is a diagram of equalizing wavelength characteristics by GSNR.

FIG. 2B is a diagram of equalizing wavelength characteristics by GSNR.

FIG. 3A is a flowchart depicting an example of conventional nonlinear SNR estimation.

FIG. 3BA is a graph for explaining problems associated with GSNR estimation by conventional techniques.

FIG. 3BB is a graph for explaining problems associated with GSNR estimation by the conventional techniques.

FIG. 4 is a graph depicting power profiles of different Raman amplifiers.

FIG. 5 is a flowchart depicting an example of a nonlinear SNR calculation process according to the embodiment.

FIG. 6A is a graph for explaining in detail calculation of a nonlinear effective length by obtaining a power profile.

FIG. 6B is a graph for explaining in detail calculation of the nonlinear effective length by obtaining the power profile.

FIG. 7 is a diagram depicting an example of hardware configuration of a controller of the optical power control device.

FIG. 8 is a flowchart depicting an example of GSNR control according to the embodiment.

FIG. 9A is a graph depicting an example of power profiles of different shapes.

FIG. 9B is a graph depicting an example of power profiles of different shapes.

FIG. 10 is a flowchart depicting another example of conventional estimation of nonlinear SNR.

FIG. 11A is a graph depicting an example of a table used in deriving nonlinear noise coefficients.

FIG. 11B is a graph depicting an example of a table used in deriving nonlinear noise coefficients.

FIG. 12 is a diagram depicting the optical transmission system including an alternative configuration example of the optical power control device according to the embodiment.

FIG. 13 is a comparison chart of examples of optical power control.

FIG. 14A is a flowchart depicting a first GSNR control example according to the optical power control device having the alternative configuration.

FIG. 14B is a flowchart depicting the first GSNR control example according to the optical power control device having the alternative configuration.

FIG. 15A is a flowchart depicting a second GSNR control example according to the optical power control device having the alternative configuration.

FIG. 15B is a flowchart depicting the second GSNR control example according to the optical power control device having the alternative configuration.

### DESCRIPTION OF THE INVENTION

In International Publication No. WO 2002/021203 and U.S. Patent Application Publication No. 2014/0147113, etc., non-linear noise of GSNR is not considered, only linear noise of Raman amplification and thus, in a case of multiband, equalization of GSNR over wavelength band is not possible.

As one countermeasure, for example, it is conceivable to implement control for equalizing GSNR over wavelength band by estimating SNR (nonlinear SNR, nonlinear noise amount) with respect to nonlinear noise and adjusting the optical power of each wavelength. While described in more detail hereinafter, for nonlinear SNR, it is conceivable to store nonlinear SNR for each wavelength in a table and to estimate SNR by correcting for factors including effects of stimulated Raman scattering (SRS) according to fiber input power. However, power profiles of signals in the fiber vary greatly due to loss profiles of pump light wavelength and as a result, nonlinear SNR varies and GSNR control is not performed accurately. While it is conceivable to measure power profiles of optical signal wavelength or pump light wavelength using an optical time domain reflectometer (OTDR), the pump light and/or optical signals may interfere and it may be impossible to measure the power profile itself. As described, nonlinear SNR cannot be measured accurately with conventional techniques. Further, since nonlinear SNR cannot be estimated accurately, GSNR of each band in multiband transmission cannot be improved.

Embodiments of an optical power control device, an optical power control method, and an optical transmission system of the present disclosure are described in detail with reference to the accompanying drawings.

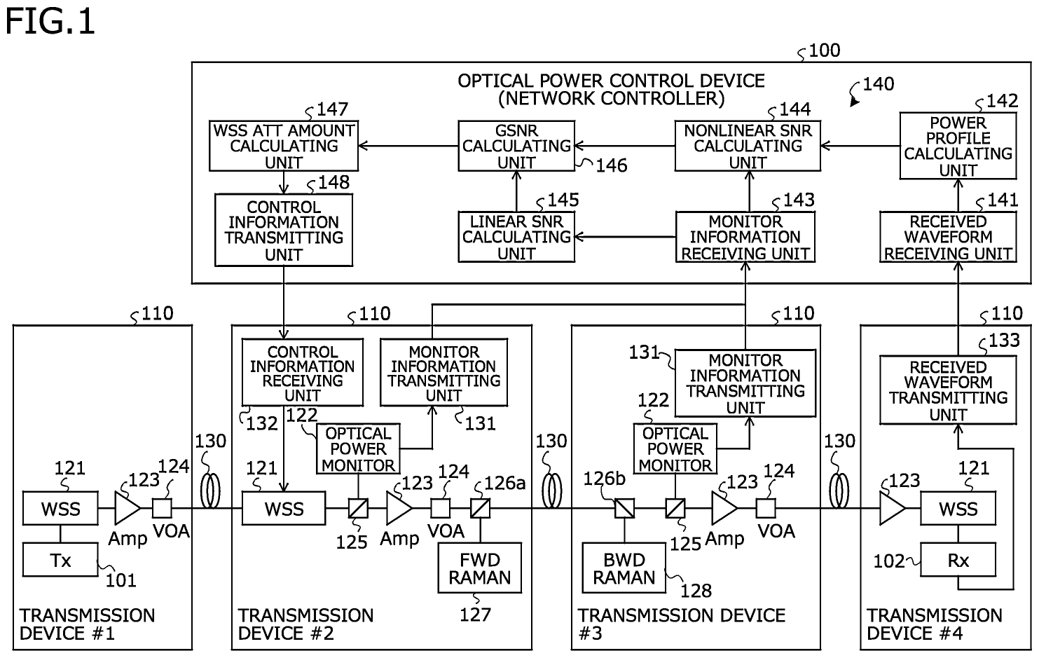

FIG. 1 is a diagram depicting an optical transmission system that includes an optical power control device according to an embodiment. The optical transmission system includes multiple transmission devices #1, #2, #3, #4 (nodes) 110 that transmit WDM signals, a transmission path 130 between the transmission devices 110, an optical power control device 100 that mainly controls optical power as well as transmission states of the transmission devices 110.

WDM signals are different bands, for example, the C-band and the L-band. The optical power control device 100, for example, has a function of a network controller (NWC) that controls management of the transmission devices #1 to #4 (110). The transmission path 130 is constituted by, for example, optical fibers. The multiple transmission devices #1 to #4 (nodes) 110 are, for example, optical repeaters, reconfigurable optical add/drop multiplexers (ROADMs) capable of branching and inserting WDM signals according to wavelength, and the like.

In the example of the system depicted in FIG. 1, the transmission device #1 (110) has a transmitting unit (Tx) 101 while the transmission device #4 (110) has a receiving unit (Rx) 102 and optical signals are transmitted between the transmission devices #1 to #4 (nodes) 110. Further, the example of the system in FIG. 1 depicts a connection example in which optical power between a pair of the transmission devices #2 to #3 (110) corresponding to an interval (1 span) of the optical power control device 100 is controlled. The optical power control device 100 may similarly perform optical power control with respect to another span by connecting to a pair of the transmission devices 110 that correspond to the span.

The transmission devices 110 include, from an optical signal input side, a wavelength selective switch (WSS) 121, an optical power monitor 122, an optical amplifier (optical amp) 123, a variable optical attenuator (VOA) 124, an optical splitter 125, and an optical coupler 126 (126a, 126b).

The optical power monitor 122 detects the optical power of an optical signal split by the optical splitter 125. The optical amplifier 123 is, for example, an erbium doped fiber amplifier (EDFA).

Further, in the transmission devices 110, a forward-pumped Raman amplifier (Fwd Raman) 127 is disposed on an output side to the transmission path 130 and a backward-pumped Raman amplifier (Bwd Raman) 128 is disposed on an input side from the transmission path 130. The forward-pumped Raman amplifier 127 outputs pump light for forward pumping for the transmission path 130, via the optical coupler 126a. The forward-pumped Raman amplifier 127 may be equipped with, for example, an i-pump and secondary pump light. The backward-pumped Raman amplifier 128 outputs pump light for backward pumping for the transmission path 130, via the optical coupler 126b. The transmission devices 110 arbitrarily combine forward pumping and backward pumping and optically amplify optical signals of the transmission path 130 by the combined pump light.

Further, the transmission devices 110 include, as functions for optical power control, a monitor information transmitting unit 131, a control information receiving unit 132, and a received waveform transmitting unit 133. The monitor information transmitting unit 131 transmits the optical power detected by the optical power monitor 122 to the optical power control device 100. The control information receiving unit 132 receives control information output by the optical power control device 100 and controls the attenuation amount (ATT value) of the WSS 121. The receiving unit (Rx) 102 of the transmission device #4 (110) at the end of the transmission path 130 receives a received waveform of the wavelength that is subject to control and the received waveform transmitting unit 133 transmits the received waveform to the optical power control device 100.

The optical power control device 100 has a controller 140 that controls the optical power of the transmission devices #1 to #4 (110). The controller 140 includes a received waveform receiving unit 141, a power profile calculating unit 142, a monitor information receiving unit 143, a nonlinear SNR calculating unit 144, a linear SNR calculating unit 145, a GSNR calculating unit 146, a WSS ATT amount calculating unit 147, and a control information transmitting unit 148.

The received waveform receiving unit 141 receives the received waveform of the wavelength that is subject to control, the received waveform being transmitted by the receiving unit (Rx) 102 of the transmission device #4 (110) at the end of the transmission path 130. The power profile calculating unit 142 uses the received waveform of the wavelength that is subject to control to calculate a power profile constituting a distribution of optical power of an optical signal in a longitudinal (distance) direction of the transmission path 130. The calculated power profile is stored to a storage unit such as a memory of the optical power control device 100.

The monitor information receiving unit 143 obtains fiber input channel power that is subject to control, the fiber input channel power being obtained by the optical power monitor 122 and transmitted by the monitor information transmitting unit 131 of the transmission device #2 (110) on the transmission side of the span interval (#2 to #3) that is subject to optical power control. Further, the monitor information receiving unit 143 obtains the optical input power of the optical amplifier 123, the optical input power being obtained by the optical power monitor 122 and transmitted by the monitor information transmitting unit 131 of the transmission device #3 (110) on the reception side of the span interval that is subject to optical power control.

The nonlinear SNR calculating unit 144 uses a predetermined calculation formula and calculates nonlinear SNR of the span interval (#2 to #3), based on the power profile calculated by the power profile calculating unit 142 and the fiber input channel power of the transmission device #2 (110). The linear SNR calculating unit 145 uses a predetermined calculation formula and calculates linear SNR of the span interval (#2 to #3), based on a noise figure (NF) and input power of the optical amplifier 123 of the transmission device #3 (110). The calculated nonlinear SNR and nonlinear SNR are stored to a storage unit of the optical power control device 100.

The GSNR calculating unit 146 calculates GSNR of the span interval (#2 to #3), based on the nonlinear SNR calculated by the nonlinear SNR calculating unit 144 and the linear SNR calculated by the linear SNR calculating unit 145. The calculated GSNR is stored to the storage unit of the optical power control device 100.

The WSS ATT amount calculating unit 147 calculates an ATT value (ch ATT value) for each channel of the WSS 121 of the transmission device #2 (110), the ATT values being calculated from a difference from a predetermined target GSNR (for example, average value of GSNR of all WDM signals, obtained by design) that is a control target. The calculated ch ATT values are stored to the storage unit of the optical power control device 100. The control information transmitting unit 148 transmits the calculated ch ATT values to the transmission device #2 (the control information receiving unit 132) on the transmission side of the span interval (#2 to #3).

In the present embodiment, the optical power control device 100 has the nonlinear SNR calculating unit 144 and calculates nonlinear SNR of the span interval. The nonlinear SNR calculating unit 144 of the embodiment uses a power profile estimation and corrects the nonlinear SNR (nonlinear noise amount). While described in detail hereinafter, a reference nonlinear SNR is estimated using values in a table for each wavelength and fiber input power values. Further, the nonlinear SNR is calculated by performing correction using a nonlinear effective length obtained from the power profile estimation and a nonlinear effective length corresponding to the reference nonlinear SNR. As a result, the nonlinear SNR may be corrected using the power profile and it becomes possible to improve the accuracy of the nonlinear SNR.

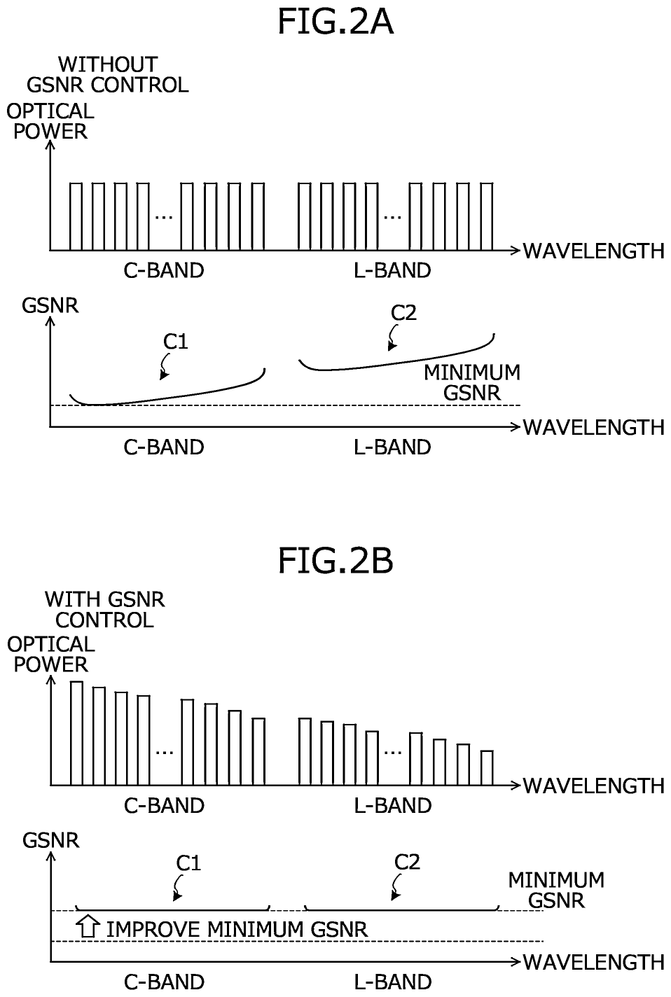

Here, problems associated with the conventional techniques are discussed. FIGS. 2A and 2B are diagrams of equalizing wavelength characteristics by GSNR. In optical transmission of the C-band and of the L-band, FIG. 2A depicts an instance of no GSNR control while FIG. 2B depicts an instance of GSNR control; in both figures, horizontal axes indicate wavelength and vertical axes indicate optical power and GSNR.

When transmission performance varies dependent on wavelength, the transmission distance and the number of wavelengths become limited and thus, conventionally, design and adjustment to suppress variation of optical power and OSNR has been performed. When a wavelength band for transmission such as a C+L band is further widened from only a C-band, as depicted in FIG. 2A, even when variation of OSNR due to wavelength is suppressed, a problem arises in that wavelength characteristics C1, C2 of GSNR (nonlinear noise+OSNR) do not become uniform.

Thus, as shown in FIG. 2B, it is conceivable to apply control that estimates the SNR relatively to linear noise and adjusts the optical power of each wavelength to make the wavelength characteristics C1 and C2 of the GSNR uniform over wavelength band.

Conventionally, under power control that takes fiber loss and ramp loss between a pair of transmission devices into consideration, the reception-side transmission device (node B) forwards linear SNR and optical power, or OSNR measured by an optical channel monitor (OCM), OTDR, etc. to the transmission-side transmission device (node A). Further, the transmission-side transmission device calculates GSNR and controls the WSS and the optical amplifier.

Based on nonlinear noise being proportional to the cube of optical power, for example, nonlinear noise is expressed by equation (1) (η: proportionality constant).

$${P}_{NLI} = η {P}_{CH ( A )}^{3} \qquad ( 1 )$$

When the band of a channel is constant, nonlinear noise per unit bandwidth (for example, 12.5 GHZ) may be expressed by equation (2) (η_{d}: proportionality constant, B_{CH}: channel bandwidth)

$${G}_{NLI} = {{η}_{d} ( {P}_{CH ( A )} / {B}_{CH} )}^{3} \qquad ( 2 )$$

Therefore, nonlinear SNR is expressed by equation (3), (P_{CH (A)}/B_{CH} is the fiber input power per unit bandwidth)

$${SNR}_{Nonlinear} = \frac{{P}_{CH ( A )} / {B}_{CH}}{{G}_{NLI}} = \frac{1}{{{η}_{d} ( {P}_{CH ( A )} / {B}_{CH} )}^{2}} \qquad ( 3 )$$

Furthermore, GSNR is obtained by linear SNR and equation (4).

$$1 / GSNR = 1 / {SNR}_{Linear} + 1 / {SNR}_{Nonlinear} \qquad ( 4 )$$

In particular, the OCM of node A measures the fiber input power per unit bandwidth at a center wavelength and calculates a value of the nonlinear SNR. Further, the value of the linear SNR measured at node B is forwarded to node A, where GSNR is calculated.

Here, a method is described for estimating nonlinear SNR in an instance in which forward-pumped Raman is applied, there is ramp loss, and there is no information on the optical power for each wavelength from an OTDR or the like. In this instance, the nonlinear SNR is stored in advance in a table for each wavelength. Further, it is conceivable to estimate nonlinear SNR by using a reference value and the fiber input power values and making corrections according to the fiber input power while taking into account the impact of tilt due to SRS. Here, differences in fiber loss coefficients are not considered and, for example, a fixed value of 0.2 dB/km is used. Nonlinear SNR, for example, may be calculated by equation (5) with consideration of signal bandwidth from nonlinear noise coefficient.

$$Nonlinear noise {coefficient [ mW / GHz ]}^{- 2} = nonlinear noise coefficient slope \times ( fiber input power - fiber input power reference value ) + nonlinear noise coefficient reference value \qquad ( 5 )$$

The nonlinear noise coefficient slope and nonlinear noise coefficient reference value above are stored in a table and the fiber input power is assumed to be a predefined value [dBm/50 GHz]. The term “nonlinear noise coefficient slope×(fiber input power−fiber input power reference value)” is corrected according to the fiber input power including the impact of SRS. Further, the nonlinear noise coefficient is converted into nonlinear SNR.

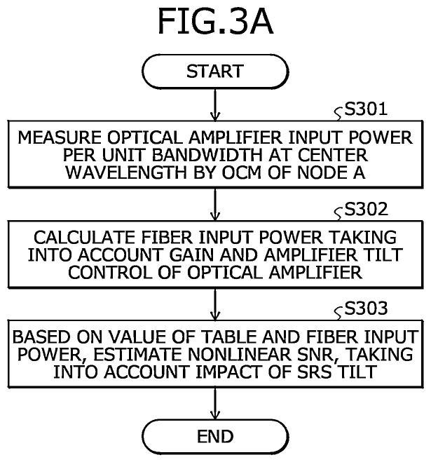

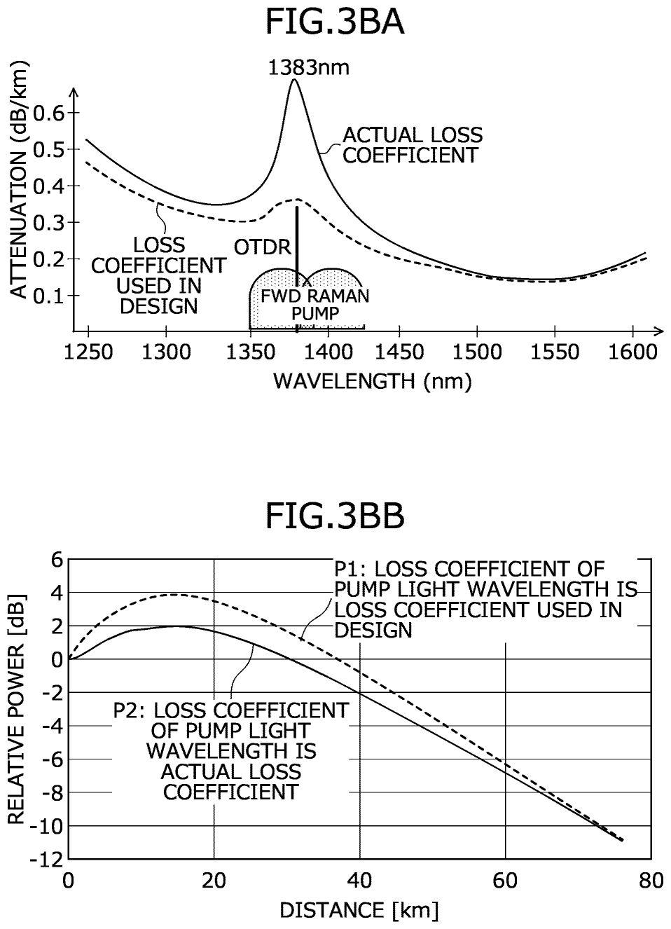

FIG. 3A is a flowchart depicting an example of conventional nonlinear SNR estimation. First, node A, via the OCM, measures the optical amplifier input power per unit bandwidth at the center wavelength (step S301). Subsequently, node A calculates the fiber input power taking into account the gain and the amplifier tilt control of the optical amplifier (step S302).

Next, based on a value of the table and the fiber input power, node A estimates the nonlinear SNR, taking into account the impact of tilt due to SRS (step S303). Nonetheless, conventionally, nonlinear SNR cannot be estimated accurately.

FIGS. 3BA and 3BB are graphs for explaining problems associated with GSNR estimation by the conventional techniques. FIG. 3BA depicts an example of wavelength arrangement of an optical signal and pump light; a horizontal axis indicating wavelength and a vertical axis indicating attenuation amount (loss coefficient). For example, in an instance in which a signal of S-band (1460 to 1530 nm) is optically amplified by forward-pumped Raman amplification, it is necessary to arrange the pump light in a band of 1360 to 1430 nm. Further, with a forward-pumped Raman amplifier, there is the problem of relative intensity noise (RIN) of the pump light and thus, use of an i-pump with a wide spectrum is necessary. On the other hand, optical fibers have a water peak at 1383 nm and it known that this amount varies greatly. Further, it is known that the amount of water peak loss deteriorates over time.

FIGS. 3BA and 3BB depict design and actual power profiles for the loss coefficient of the pump light wavelength. It is possible to control the power of pump light so that ON/OFF gain becomes a target value by monitoring and controlling the optical amplifier input power to be a predetermined power. However, the power profile of a signal in the fiber varies greatly depending on the loss profile of the pump light wavelength and thus, as a result, nonlinear SNR varies and the accuracy of the GSNR control is impacted.

As depicted in the power profile in FIG. 3BB, even when the fiber input power at 0 km is the same, if the nonlinear SNR is different, characteristics of a loss coefficient P2 of the actual pump light wavelength are different from characteristics of a loss coefficient P1 of the pump light wavelength used in the design and variation in nonlinear SNR occurs.

As a countermeasure for this, while it is conceivable to measure the power profile of the optical signal wavelength or the pump light wavelength by OTDR, the pump light or the optical signal light interferes and measurement by OTDR is not possible.

The controller 140 of the optical power control device 100 of the embodiment corrects the nonlinear SNR, using the power profile. The control unit 140 approximately calculates the nonlinear SNR by equation (6), using reference standard values (nonlinear SNR_{ref}, P_{0,ref}, L_{eff,ref}, γ_{ref}) of each parameter obtained in advance through simulation and transmission experiments.

$$nonlinear SNR ( {P}_{0 , Left} , γ ) = nonlinear {SNR}_{ref} - 2 \times ( {P}_{0} - {P}_{0 , ref} ) - 2 \times 10 log ( {L}_{eff} / {L}_{eff , ref} ) - 2 \times 10 log ( γ / {γ}_{ref} ) [ dB in reception band ] \qquad ( 6 )$$

(Where, P₀: fiber input power [dBm], L_{eff}: nonlinear effective length [km], γ: nonlinear coefficient)

Further, the nonlinear effective length L_{eff} is expressed as equation (7).

$${L}_{eff} = \int [ 0 to L ] \vert P ( z ) / {P}_{0} \vert dz \qquad ( 7 )$$

(Where, P(z): optical power [W] at point z, P₀: fiber input power [W], L: fiber length [km])

The nonlinear coefficient is expressed by equation (8).

$$nonlinear coefficient : γ = ( {n}_{2} {ω}_{0} ) / ( {cA}_{eff} ) = ( {n}_{2} 2 π f ) / ( {cA}_{eff} ) = 2 π {cn}_{2} / ( {A}_{eff} / λ ) \qquad ( 8 )$$

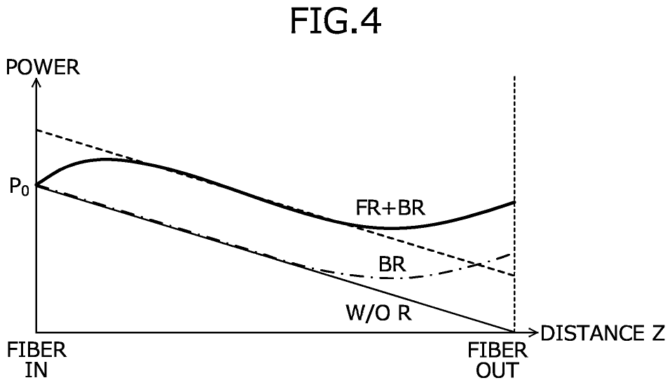

FIG. 4 is a graph depicting power profiles of different Raman amplifiers. In the description above, as for the fiber input power, the nonlinear effective length, and the nonlinear coefficient, the nonlinear SNR may be corrected if the actual system values are known. The controller 140 calculates the nonlinear effective length L_{eff} from the power profile estimation results and thereby, improves the accuracy of the nonlinear SNR. The controller 140 uses the power profile estimation results of the different types of Raman amplification (BR: backward pumping, FR+BR: forward pumping+backward pumping, w/o R: no Raman amplification) of the system depicted in FIG. 4.

The controller 140 of the optical power control device 100 uses values stored in a table according to wavelength and the fiber input power values to estimate the reference nonlinear SNR. Subsequently, the controller 140 uses the nonlinear effective length obtained from the power profile estimation and the nonlinear effective length corresponding to the reference nonlinear SNR to perform corrections and calculate the nonlinear SNR, as expressed by equation (9).

$$nonlinear SNR [ dB ] = nonlinear {SNR}_{ref} - 2 \times 10 log ( {L}_{eff} / {L}_{eff , ref} ) \qquad ( 9 )$$

Of the terms above, the nonlinear SNR_{ref} is estimated by a same technique as that used conventionally. L_{eff} is the nonlinear effective length obtained from the power profile estimation (PPE) and L_{eff,ref} is the nonlinear effective length corresponding to the nonlinear SNR_{ref}. The linear SNR may be easily calculated from the noise of the optical amplifier of the reception-side node by a same technique as that used conventionally.

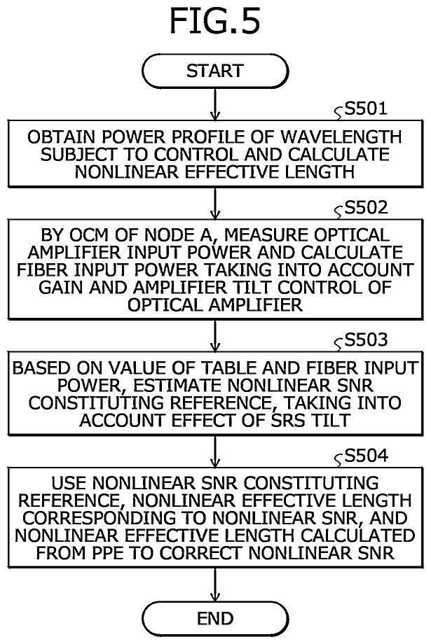

FIG. 5 is a flowchart depicting an example of a nonlinear SNR calculation process according to the embodiment. The process depicted in FIG. 5 is executed by the controller 140 of the optical power control device 100 and, for example, a CPU executes the process. First, the controller 140 obtains the power profile of the wavelength that is subject to control and calculates the nonlinear effective length (step S501).

Next, the controller 140, via the OCM of node A (the transmission device 110 on the transmission-side), measures the optical amplifier input power and calculates the fiber input power taking into account the gain and the amplifier tilt control of the optical amplifier (step S502).

Next, the controller 140, based on a value of a table (the power profile) and the fiber input power, takes into account the effect of SRS tilt and estimates a nonlinear SNR constituting a reference (step S503).

Subsequently, the controller 140 uses the nonlinear SNR constituting a reference, the nonlinear effective length that corresponds to the nonlinear SNR, and the nonlinear effective length calculated from the PPE to correct the nonlinear SNR (step S504).

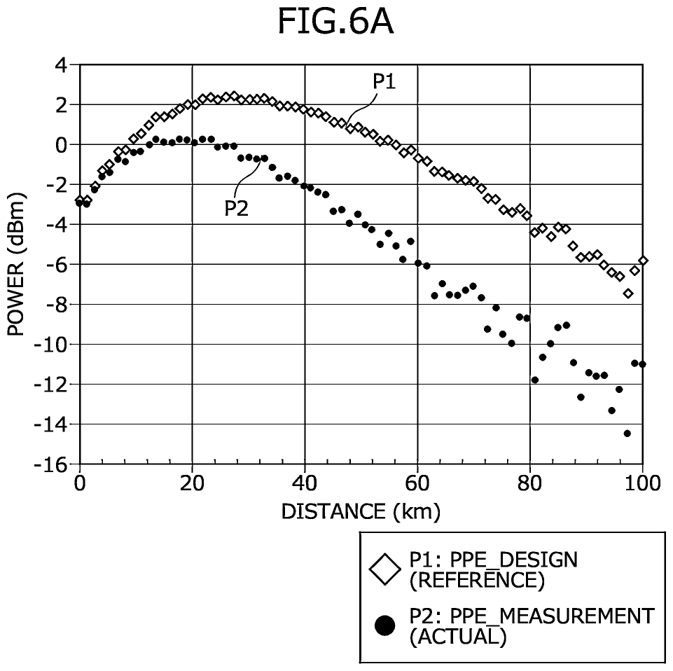

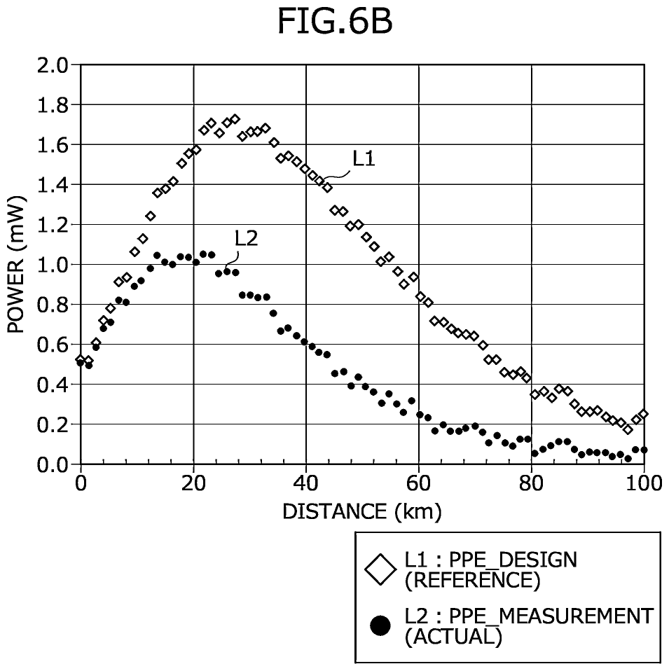

FIGS. 6A and 6B are graphs for explaining in detail calculation of the nonlinear effective length by obtaining the power profile. A process in which the controller 140 obtains the power profile of the wavelength that is subject to control in FIG. 5 and calculates the nonlinear effective length L_{eff} (equation (7)) (step S501) is described in detail.

The controller 140 uses the received waveform received by the transmission device #4 (110) at the end of the transmission path 130 and calculates the power in, for example, 1 km increments and thereby, obtains the power profile depicted in FIG. 6A. In FIG. 6A, a horizontal axis indicates distance from the transmission device #1 (110) on the transmission-side while a vertical axis indicates power. The controller calculates both a design value (Reference) P1 of the PPE and an actual measured value P2.

Further, FIG. 6B shows the nonlinear effective length, a horizontal axis indicating distance and a vertical axis indicating power. The controller 140 converts logarithmic display into real number (mW) display and calculates power in 1 km increments to thereby, calculate a nonlinear effective length L1 (design value) and a nonlinear effective length L2 (actual).

The nonlinear SNR is calculated by, for example, equation (10)

$$\begin{matrix}{SNR}_{NLI} = Ps / {P}_{NLI} \\ = Ps / ( {ηΔ}_{fB} \times {Ps}^{3} ) \\ = 1 / ( {ηΔ}^{fB} \times {Ps}^{2} ) \\ = 1 / ( K {γ}^{2} {L}_{eff}^{2} Δ {f}_{B} {Ps}^{2} )\end{matrix} \qquad ( 10 )$$

(Where, Ps: fiber input power [dBm], ηΔ_{IB}: nonlinear noise=Kγ²L_{eff}²Δf_{B}, K: constant determined by dispersion, fiber length, loss, etc., γ: nonlinear coefficient, L_{eff}: nonlinear effective length, Δf_{B}: signal bandwidth)

Correction of nonlinear SNR using the reference nonlinear SNR is described. A ratio between nonlinear SNR and the reference nonlinear SNR is expressed by equation (11).

$$\begin{matrix}{SNR}_{NLI} / {SNR}_{NLI , ref} = ( 1 / ( K {γ}^{2} {L}_{eff}^{2} Δ {f}_{B} \times {Ps}^{2} ) ) / \\ ( 1 / ( K {γ}_{rel}^{2} {L}_{eff , ref}^{2} Δ {f}_{B} \times {Ps}_{ref}^{2} ) ) \\ = 1 / {( γ / {γ}_{ref} )}^{2} \times {( {L}_{eff} / {L}_{eff , ref} )}^{2} \times {( Ps / {Ps}_{ref} )}^{2}\end{matrix} \qquad ( 11 )$$

Expressed by equation (12) for conversion into a logarithm.

$${SNR}_{NLI} - {SNR}_{NLI , ref} = - 2 \times ( Ps - {Ps}_{ref} ) - 2 \times 10 log ( {L}_{eff} / {L}_{eff , ref} ) - 2 \times 10 log ( γ / {γ}_{ref} ) [ dB ] \qquad ( 12 )$$

Expressed by equation (13) when the fiber input power and the nonlinear coefficient are assumed to be the same. Equation (13) is the same as equation (9) above.

$${SNR}_{NLI} = {SNR}_{NLI , ref} - 2 \times 10 log ( {L}_{eff} / {L}_{eff , ref} ) [ dB ] \qquad ( 13 )$$

As described, the controller 140 calculates the nonlinear effective length from the power profile and thereby, corrects the nonlinear SNR.

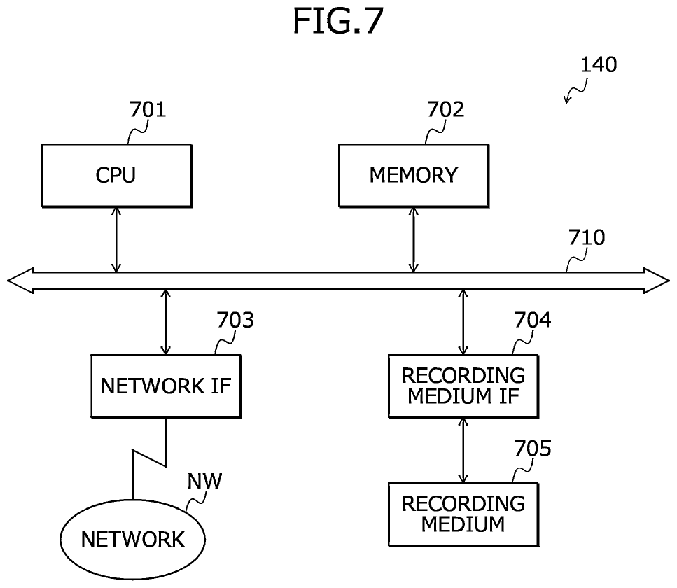

FIG. 7 is a diagram depicting an example of hardware configuration of the controller of the optical power control device. The controller 140 of the optical power control device 100 depicted in FIG. 1 may be configured by, for example, the hardware depicted in FIG. 7.

For example, the controller 140 has a processor 701 such as a central processing unit (CPU), a memory 702, a network interface (IF) 703, a recording medium IF 704, and a recording medium 705. Further, the components are each connected by a bus 710.

Here, the processor 701 is a controller that governs overall control of the controller 140. The processor 701 may have multiple cores. The memory 702 includes, for example, a read-only memory (ROM), a random-access memory (RAM), and a flash ROM, etc. In particular, for example, the flash ROM stores control programs, the ROM stores application programs, and the RAM is used as a work area of the processor 701. Programs stored in the memory 702 are loaded onto the processor 701, whereby encoded processes are executed by the processor 701.

The network IF 703 administers an internal interface with a network NW and controls the input and output of information with respect to an external device.

The recording medium IF 704, under the control of the processor 701, controls the reading and writing of data with respect to the recording medium 705. The recording medium 705 stores data written thereto under the control of the recording medium IF 704.

The controller 140 may further include, for example, an input device, a display, etc. connectable via an IF.

The processor 701 depicted in FIG. 7 may realize functions of the optical power control of the optical power control device 100 depicted in FIG. 1, by executing programs. For example, the processor 701 may realize functions of the power profile calculating unit 142, the nonlinear SNR calculating unit 144, the linear SNR calculating unit 145, the GSNR calculating unit 146, and the WSS ATT amount calculating unit 147. Further, using the memory 702 and the recording medium 705 depicted in FIG. 7, the processor 701 may realize functions of the storage unit in which information of the power profile calculated by the power profile calculating unit 142 is stored.

Further, functions related to a communications process of the optical power control device 100 depicted in FIG. 1, for example, functions of the received waveform receiving unit 141, the monitor information receiving unit 143, and the control information transmitting unit 148, may be realized via the network IF 703 depicted in FIG. 7. Further, the network NW between the optical power control device 100 and the transmission devices 110 is, for example, an Ethernet (registered trademark) or the like, the network NW performing communication via electrical signals.

The controller 140 having the hardware configuration depicted in FIG. 7 is further provided in the transmission devices 110 and controls the transmission devices 110.

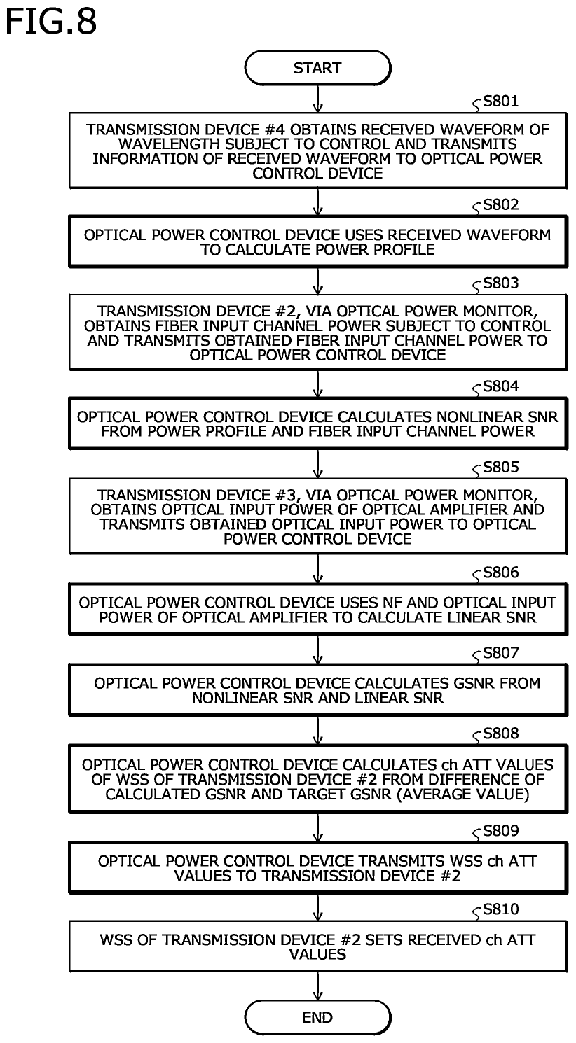

FIG. 8 is a flowchart depicting an example of GSNR control according to the embodiment. As an example, an instance is described in which the fiber input channel power is controlled between the transmission devices #2 to #3 (110), which correspond to the span subject to control depicted in FIG. 1. The overall process depicted in FIG. 8 is mainly controlled by the controller 140 of the optical power control device 100 depicted in FIG. 1. In FIG. 8, bold frames indicate processes executed by the controller 140 of the optical power control device 100.

First, the transmission device #4 (110) at the end of the transmission path 130 obtains the received waveform of the wavelength that is subject to control and transmits information of the received waveform to the optical power control device 100 (step S801). Subsequently, the optical power control device 100 (the controller 140) uses the received waveform to calculate the power profile (step S802).

Next, the transmission device #2 (110), via the optical power monitor, obtains the fiber input channel power that is subject to control and transmits the obtained fiber input channel power to the optical power control device 100 (step S803). Subsequently, the optical power control device 100 calculates the nonlinear SNR from the calculated power profile and the fiber input channel power (step S804).

Next, the transmission device #3 (110), via the optical power monitor, obtains the optical input power of the optical amplifier and transmits the obtained optical input power to the optical power control device 100 (step S805). Subsequently, the optical power control device 100 uses the NF and the optical input power of the optical amplifier to calculate the linear SNR (step S806).

Next, the optical power control device 100 calculates the GSNR from the nonlinear SNR and the linear SNR (step S807). Next, the optical power control device 100 calculates ch ATT values of the WSS 121 of the transmission device #2 (110) from a difference of the calculated GSNR and the target GSNR (average value) (step S808). Subsequently, the optical power control device 100 transmits the calculated WSS ch ATT values to the transmission device #2 (110) (step S809). Subsequently, the WSS 121 of the transmission device #2 (110) sets the received ch ATT values (step S810) and ends the process.

A modification example of the embodiment is described. First, an example of derivation of the target GSNR in the GSNR control is described. In the description above, the target GSNR in the GSNR control is assumed as the average value of the GSNR of all the WDM signals, obtained by design. However, the actual average GSNR value may be different from the design value. Therefore, the GSNR of the wavelength in operation is derived using the nonlinear SNR obtained from the power profile and the calculated value may be used to correct the value of the target GSNR.

Next, expediting obtaining the power profile used in the GSNR control is described. For example, by making the step granularity of the power profile estimation coarse, the number of calculation points may be reduced and the speed of calculation may be increased. To calculate the nonlinear noise amount, knowing the integral value of the power in the distance direction, not the power profile shape, suffices and so it is possible to make the step granularity coarse.

In addition, variance values at the start and end points of the power profile estimation may be limited to reduce the number of calculation points and thereby increase the speed. Since the nonlinear noise affects only a vicinity of the fiber input end (for example, 0 to 40 km), it is highly likely that calculations do not need to be performed for areas far from the fiber input end (for example, 40 to 80 km).

Next, the conventional technique and the embodiment are compared. For example, conventionally, as described with reference to FIG. 3BA, 3BB, it is conceivable to set a target gain for forward-pumped Raman (FWD Raman) based on the fiber type and span loss, and to set the target gain to power of pump light indicated in a table. In this instance, the nonlinear SNR is estimated from the wavelength and gain, information of the fiber input power, and parameters of nonlinear noise coefficients stored in a table. However, span loss that can be measured by an OTDR or an OCM is the same as the ON/OFF gain of FWD Raman, and in an instance in which only the shapes of the power profiles are different, a difference in the nonlinear SNRs occurs.

In contrast, in the embodiment, the power profile is actually measured and the nonlinear SNR is calculated from the actual measurement results, whereby a difference in the shapes of the power profiles may be corrected.

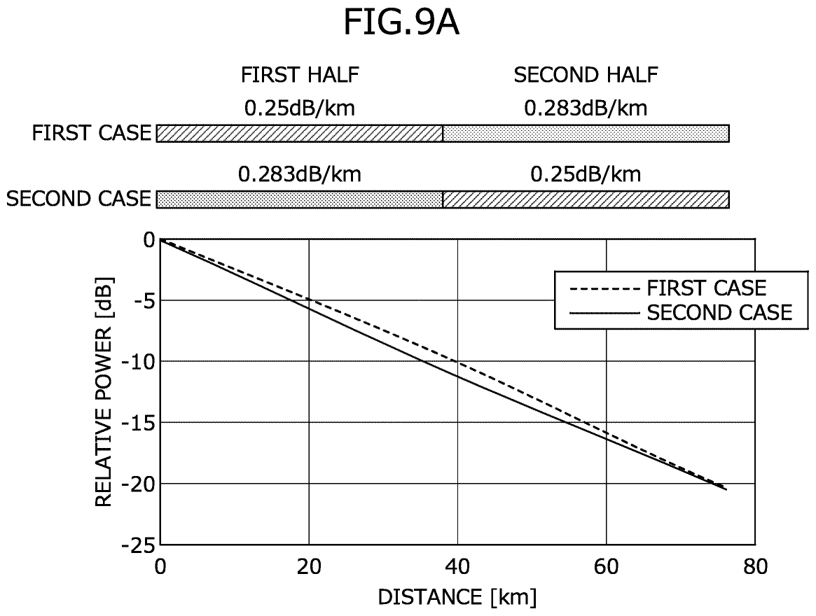

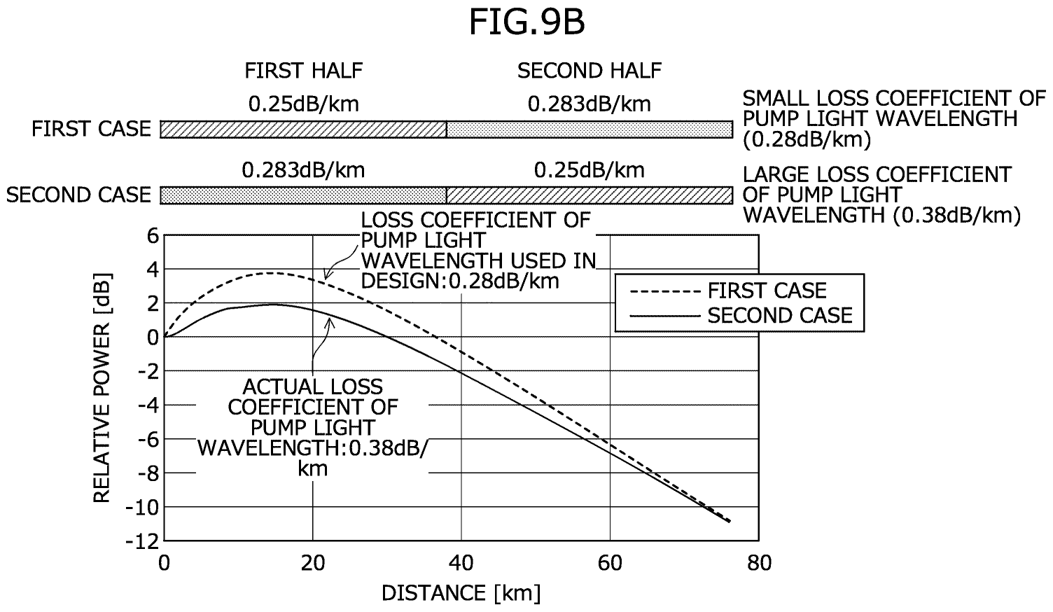

FIGS. 9A and 9B are graphs depicting examples of power profiles of different shapes. In FIGS. 9A and 9B, horizontal axes indicate distance and vertical axes indicated relative power, a first case being a power profile obtained by the conventional technique, and a second case being a power profile of the embodiment.

Here, in FIG. 9B, in the design (corresponds to the first case), the amount of nonlinear noise at a Raman gain with a loss coefficient of 0.28 dB/km in the pump light wavelength band is calculated taking into account the span loss and the fiber input power. In actuality (corresponds to the second case), the loss coefficient of the pump light wavelength band is 0.38 dB/km, the Raman gain differs from the design value, a loss coefficient of a main signal wavelength band differs from the design in a first half (0.25 dB/km) and a second half (0.283 dB/km) of the span. However, the ON/OFF gains of the FWD Raman are the same and the span losses are the same conditions. Thus, in the conventional technique, while control is performed by parameters that are the same as the design (the first case), in actuality (the second case), the power profile and the shape are different and a difference in the nonlinear noise amount occurs.

Here, FWD Raman amplification is expressed by equation (14).

$$G = exp \{ \frac{0.5 \cdot γ \cdot {P}_{p}}{α \cdot S} \} \qquad ( 14 )$$

As for a loss coefficient of a pump wavelength, in an instance in which a value used in the design is 0.28 dB/km and the actual value is 0.38 dB/km, by equation (14), variation is only by a fiber loss coefficient. The gain for a loss coefficient of 0.28 dB/km is 7 dB whereas in an instance in which the loss coefficient is 0.38 dB/km, the gain is 5.15 dB and difference of about 1.85 dB occurs.

When the first case assumes a condition that, by a conventional method, the design value is stored to a table, in the second case, which is an actual instance, the nonlinear noise amount has a difference of 3.2 dB with respect to the first case.

In the conventional GSNR control, the calculated GSNR is 23.9 dB when the linear SNR is 26 dB and the nonlinear SNR is 28 dB. In an instance in which the nonlinear noise amount is 3.2 dB smaller, the linear SNR is 26 dB and the nonlinear SNR is 31.2 dB, whereby the GSNR is 24.9 dB and in the second case (conventional technique), an error of 1.0 dB per span occurs. As a result, according to the embodiment, it is possible to improve the GSNR by 1.0 dB compared to the conventional method.

In the description of the conventional technique above, a method for estimating nonlinear SNR is described when forward-pumped Raman (FWD Raman) is applied, there is ramp loss, and there is no information on optical power for each wavelength from an OTDR or the like. Here, problems associated with estimating the nonlinear SNR when forward-pumped Raman is applied, there is ramp loss, and there is information on optical power for each wavelength from an OTDR or the like are described.

As described, in an instance in which OTDR information may be used, the nonlinear SNR is stored in a table in advance for each wavelength. Further, it is conceivable to estimate the nonlinear SNR by using a value constituting a reference and the fiber input power values, by performing correction according to the fiber input power and with consideration of the effect of tilt due to SRS. Here, the fiber loss coefficients being different is not considered and, for example, a fixed value of 0.2 dB/km is used. The nonlinear SNR is calculated from the nonlinear noise coefficient by taking into account the signal bandwidth, using equation (5) above.

Here, in an instance in which the position and amount of ramp loss is known via an OTDR, in equation (5), the nonlinear noise coefficient slope has to be corrected according to the position and the amount of ramp loss.

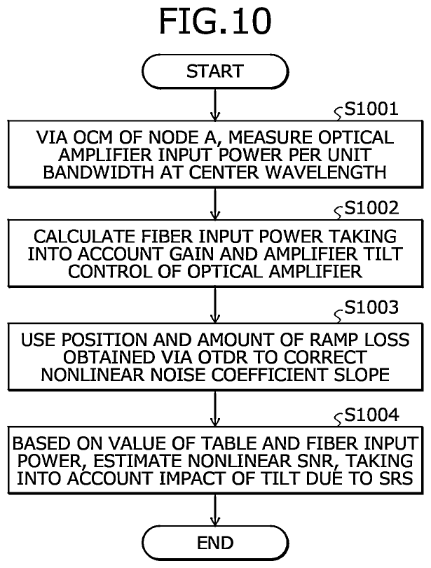

FIG. 10 is a flowchart depicting another example of conventional estimation of nonlinear SNR. In FIG. 10, processes at step S1001, step S1002, and step S1004 are the same as the processes at step S301, step S302, and step S304 depicted in FIG. 3. First, node A, via the OCM, measures the optical amplifier input power per unit bandwidth at the center wavelength (step S1001). Subsequently, node A calculates the fiber input power taking into account the gain and the amplifier tilt control of the optical amplifier (step S1002).

Next, node A uses the position and amount of ramp loss obtained via the OTDR and corrects the nonlinear noise coefficient slope (step S1003). Subsequently, based on a value of the table and the fiber input power, node A estimates the nonlinear SNR, taking into account the impact of tilt due to SRS (step S1004).

However, deriving a correction equation for correcting the value of the nonlinear noise coefficient slope according to the position and amount of the ramp loss is difficult. Therefore, for example, a method is considered in which correction values for the nonlinear noise coefficient slope are derived in advance by simulation or the like for combinations of positions and amounts of ramp loss, the correction values are stored to a table and are used for interpolation.

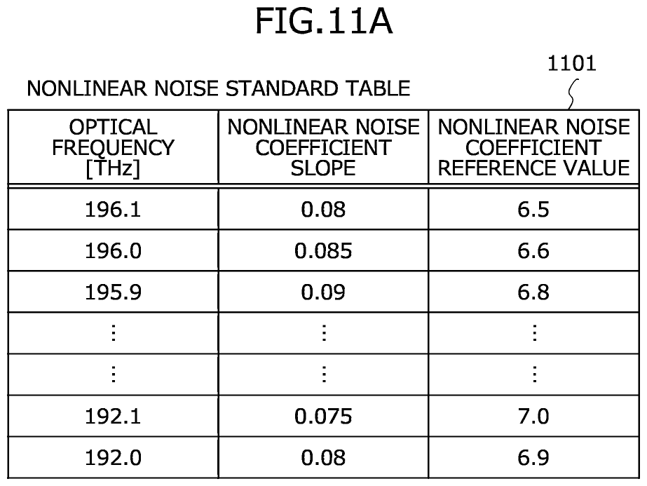

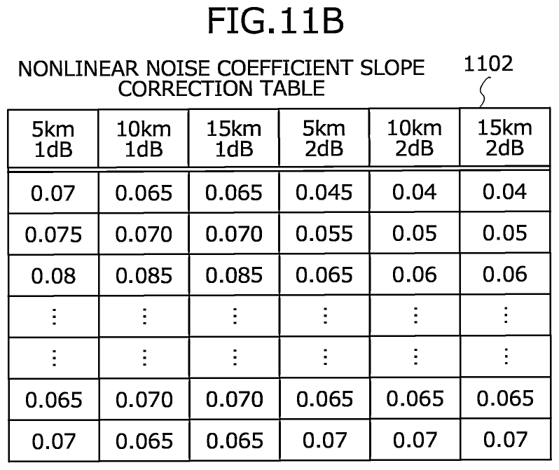

FIGS. 11A and 11B are graphs depicting examples of tables used in deriving the nonlinear noise coefficients. It is conceivable that the nonlinear noise coefficients, for example, are used in combination with a nonlinear noise standard table 1101 depicted in FIG. 11A and a nonlinear noise coefficient slope correction table 1102 depicted in FIG. 11B.

In the nonlinear noise standard table 1101 depicted in FIG. 11A, for each optical frequency, a nonlinear noise coefficient slope and a nonlinear noise coefficient reference value are set. In the nonlinear noise coefficient slope correction table 1102 depicted in FIG. 11B, a correction value is set for the nonlinear noise coefficient slope for each distance (position), and node A interpolates the slope using a correction value.

However, there are two variables: the position and the amount of ramp loss and thus, a problem arises in that interpolation is difficult. A further problem arises in that in the creation of the tables themselves, labor for creating a database increases. It is conceivable that combinations of the position and amount of ramp loss, FWD Raman gain, wavelength, and fiber type are used in creating the nonlinear noise table.

In this instance, for example, when the position of ramp loss is assumed as 1 km increments for 20 km, there are 20 types; when the amount of ramp loss is assumed as 0.5 dB increments for 3 dB, there are 6 types, and there are 6 types of FWD Raman gain. Further, when the wavelength is assumed as 100 GHz intervals on C+L-band, there are 90 types and there are 6 fiber types, for example, single mode fiber (SMF), dispersion shifted fiber (DSF), ELEAF (NZ-DSF), etc. In creating combinations of these, it would take effort to create a database of 388,800=20×6×6×90×≈400,000 combinations, and it is not practical to keep all of these in a database.

As described, in contrast to the conventional technique in which nonlinear noise coefficients are set in a table, it is possible to reduce the number of steps and the processing load for creating a database by correcting the nonlinear SNR using power profile estimation as in the embodiment.

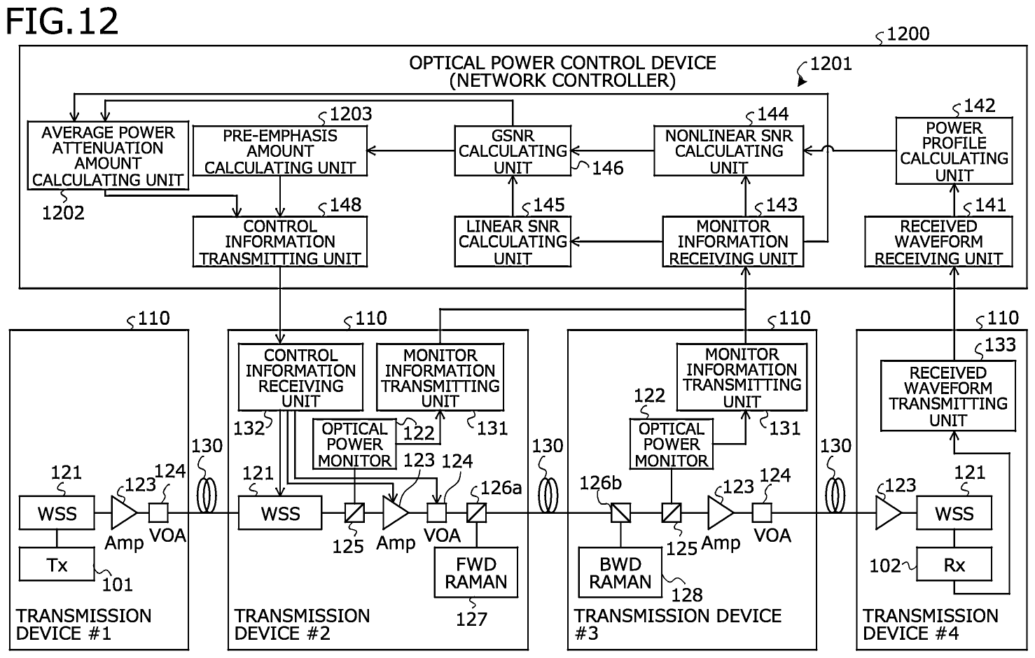

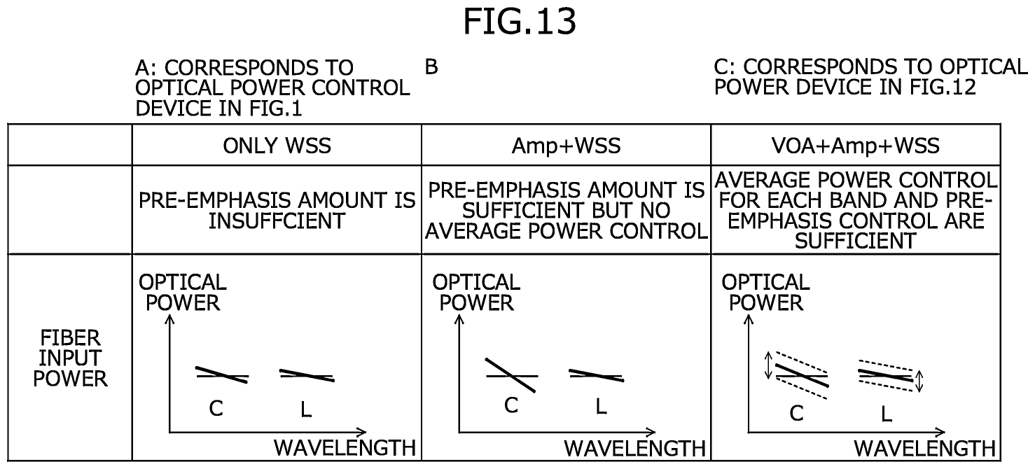

FIG. 12 is a diagram depicting the optical transmission system including an alternative configuration example of the optical power control device according to the embodiment. In FIG. 12, components that are the same as components depicted in FIG. 1 are given the same reference numerals used in FIG. 1. In the controller 140 of the optical power control device 100 depicted in FIG. 1, the WSS ATT amount calculating unit 147 is provided. In contrast, a controller 1201 of an optical power control device 1200 having the configuration depicted in FIG. 12 includes an average power attenuation amount calculating unit 1202 and a pre-emphasis amount calculating unit 1203, instead of the WSS ATT amount calculating unit 147.

The controller 140 of the optical power control device 100 described with reference to FIG. 1 merely controlled the WSS 121 of the transmission devices 110. In contrast, the controller 1201 of the optical power control device 1200 having the configuration depicted in FIG. 12 controls the WSS 121, the optical amplifier 123, and a VOA 124 of the transmission devices 110.

In the optical power control device 1200, the controller 1201 controls the optical power of the transmission devices #1 to #4 (110). The controller 1201 includes the received waveform receiving unit 141, the power profile calculating unit 142, the monitor information receiving unit 143, the nonlinear SNR calculating unit 144, the linear SNR calculating unit 145, the GSNR calculating unit 146, the control information transmitting unit 148, the average power attenuation amount calculating unit 1202, and the pre-emphasis amount calculating unit 1203.

Further, while the configuration of the transmission devices 110 depicted in FIG. 12 is the same as the configuration of those depicted in FIG. 1, the control information receiving unit 132 receives control information output by the optical power control device 1200 and controls the average power attenuation amount of the VOA 124, the gain and tilt amount of the optical amplifier 123, and the attenuation amount (the ATT value) the WSS 121.

The received waveform receiving unit 141 receives the received waveform of the wavelength that is subject to control, the received waveform being output from the receiving unit (Rx) 102 and transmitted by the received waveform transmitting unit 133 of the transmission device #4 (110) at the end of the transmission path 130. The power profile calculating unit 142 uses the received waveform of the wavelength that is subject to control to calculate the power profile, which is distribution of the optical power of the optical signal in the longitudinal (distance) direction of the transmission path 130. The calculated power profile is stored to a storage unit such as memory of the optical power control device 1200.

The monitor information receiving unit 143 obtains the fiber input channel power that is subject to control, the fiber input channel power being obtained by the optical power monitor 122 and transmitted by the monitor information transmitting unit 131 of the transmission device #2 (110) on the transmission-side of the span interval (#2 to #3) that is subject to optical power control. Further, the monitor information receiving unit 143 obtains the optical input power of the optical amplifier 123, the optical input power being obtained by the optical power monitor 122 and transmitted by the monitor information transmitting unit 131 of the transmission device #3 (110) on the reception-side of the span interval subject to optical power control.

The nonlinear SNR calculating unit 144, based on the power profile calculated by the power profile calculating unit 142 and the fiber input channel power of the transmission device #2 (110), uses a predetermined calculation formula to calculate the nonlinear SNR of the span interval (#2 to #3). The linear SNR calculating unit 145, based on the noise figure (NF) and the input power of the optical amplifier 123 of the transmission device #3 (110), uses a predetermined calculation formula to calculate the linear SNR of the span interval (#2 to #3). The calculated nonlinear SNR and linear SNR are stored to the storage unit of the optical power control device 1200.

The GSNR calculating unit 146 calculates the GSNR of the span interval (#2 to #3), based on the nonlinear SNR calculated by the nonlinear SNR calculating unit 144 and the linear SNR calculated by the linear SNR calculating unit 145. The calculated GSNR is stored to the storage unit of the optical power control device 1200.

The average power attenuation amount calculating unit 1202 and the pre-emphasis amount calculating unit 1203 calculate the average power attenuation amount and the pre-emphasis amount of the transmission device #2 (110) from a difference with a predetermined target GSNR (for example, the average value of the GSNR of all the WDM signals, the average value of the GSNR being obtained by design) that is the control target, and from the calculated pre-emphasis amount, calculate the gain and tilt amount of the optical amplifier 123, and an attenuation amount (the ATT value) for each channel of the WSS 121. The calculated average power attenuation amount of the VOA 124, the gain and tilt amount of the optical amplifier 123, and the attenuation amounts (the ATT values) for the WSS 121 are stored to the storage unit of the optical power control device 1200. The control information transmitting unit 148 transmits the calculated average power attenuation amount of the VOA 124, the gain and tilt amount of the optical amplifier 123, the attenuation amounts (the ATT values) of the channels of the WSS 121 to the transmission device #2 (the control information receiving unit 132) on the transmission-side of the span interval (#2 to #3).

When forward-pumped Raman pumping starts by the forward-pumped Raman amplifier (Fwd Raman) 127, the transmission devices 110 monitor the optical power by an optical power monitor (PD) provided in a preamplifier (the optical amplifier 123), etc. and adjust the power of Raman pump light so as to achieve a predetermined gain.

FIG. 13 is a comparison chart of examples of optical power control. In FIG. 13, columns A, B, and C depict characteristics of the transmission device #2 (110) that is subject to optical power control, where a horizontal axis indicates wavelength while a vertical axis indicates optical power. In FIG. 13, column A depicts a control state of the transmission device #2 (110) by the controller 140 of the optical power control device 100 depicted in FIG. 1. In the controller 140 of the optical power control device 100 depicted in FIG. 1, only the WSS 121 of the transmission device #2 (110) is controlled and the power is controlled in units of channel for each band (for example, the C-band, the L-band). However, to suppress decreases in the input power and degradation of OSNR of the optical amplifier 123 provided downstream of the WSS 121 of the transmission device #2 (110), preferably, the average ATT value of the WSS 121 is set to be small and in this case, the amount of pre-emphasis that may be adjusted by the WSS 121 is limited.

In FIG. 13, column B depicts a state assuming control of the WSS 121 and the optical amplifier 123 of the transmission device #2 (110). In this case, while the amount of pre-emphasis of each band is sufficient, the average power is not controlled and optical power control of each band is necessary to cope with NF degradation.

In FIG. 13, column C depicts a control state of the transmission device #2 (110) by the controller 1201 of the optical power control device 1200, having the alternative configuration depicted in FIG. 12. In the optical power control device 1200, based on the calculation of the pre-emphasis amount and the average power attenuation amount, the gain and tilt amount of the optical amplifier 123 of the transmission device #2 (110), attenuation amount for each channel of the WSS 121, and the average power attenuation amount of the VOA 124 are each controlled, whereby average power control for each band and pre-emphasis control can both be sufficiently controlled. While the average power control for each band may also be performed by the optical amplifier 123, the control by the optical amplifier 123 degrades the NF and thus, control by the VOA 124 on the output-side is preferable.

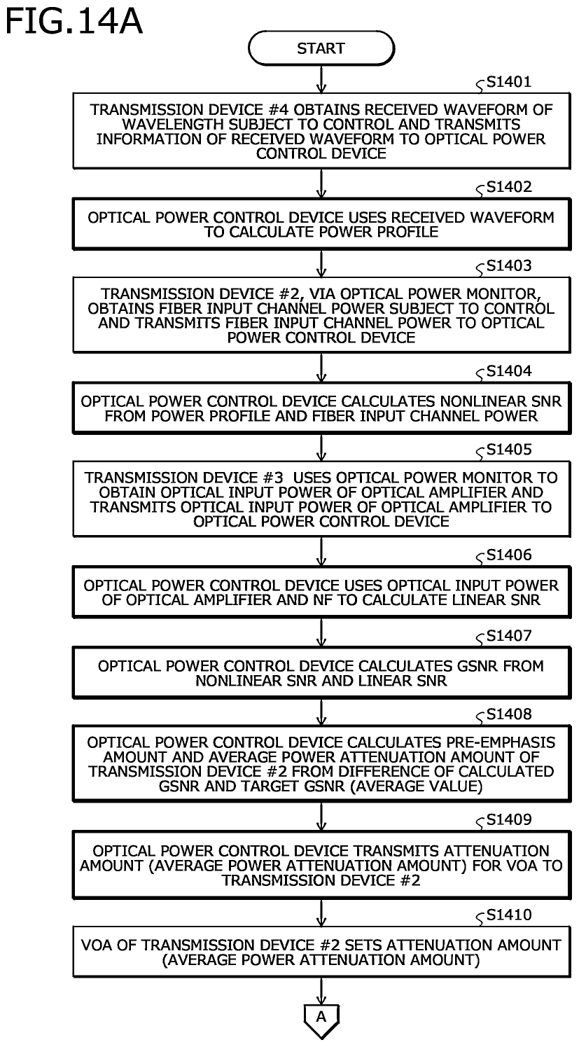

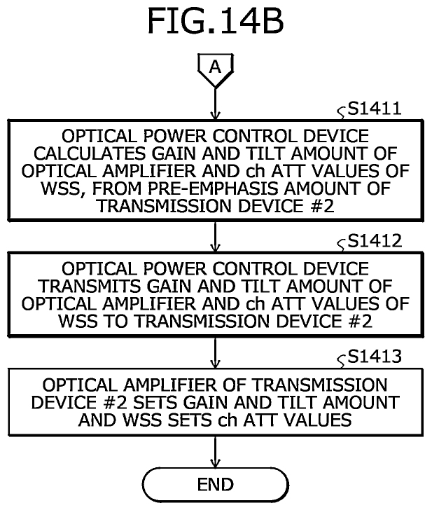

FIGS. 14A and 14B are flowcharts depicting a first GSNR control example according to the optical power control device having the alternative configuration. A control example is described for an instance in which fiber input channel power between the transmission devices #2 to #3 (110) corresponding to the span subject to control depicted in FIG. 12 is controlled. The process below is mainly controlled by the controller 1201 of the optical power control device 1200 depicted in FIG. 12. Thick frames in FIG. 8 indicate processes executed by the control unit 1201 of the optical power control device 1200.

First, as depicted in FIG. 14A, the transmission device #4 (110) at the end of the transmission path 130 obtains the received waveform of the wavelength that is subject to control and transmits information of the received waveform to the optical power control device 1200 (step S1401). Subsequently, the optical power control device 1200 (the controller 1201) uses the received waveform to calculate the power profile (step S1402).

Next, the transmission device #2 (110), via the optical power monitor, obtains the fiber input channel power that is subject to control and transmits the fiber input channel power to the optical power control device 1200 (step S1403). Subsequently, the optical power control device 1200 calculates the nonlinear SNR from the calculated the power profile and the fiber input channel power (step S1404).

Next, the transmission device #3 (110) uses the optical power monitor and obtains the optical input power of the optical amplifier and transmits the optical input power of the optical amplifier to the optical power control device 1200 (step S1405). Subsequently, the optical power control device 1200 uses the optical input power of the optical amplifier and the NF to calculate the linear SNR (step S1406).

Next, the optical power control device 1200 calculates the GSNR from the nonlinear SNR and the linear SNR (step S1407). Next, the optical power control device 1200 calculates the pre-emphasis amount and the average power attenuation amount of the transmission device #2 (110) from a difference of the calculated GSNR and the target GSNR (average value) (step S1408). Subsequently, the optical power control device 1200 transmits the calculated attenuation amount (the average power attenuation amount) for the VOA 124 to the transmission device #2 (110) (step S1409). Subsequently, the VOA 124 of the transmission device #2 (110) sets the transmitted average power attenuation amount (step S1410).

Further, as depicted in FIG. 14B, the optical power control device 1200 calculates the gain and tilt amount of the optical amplifier 123 and the ch ATT values of the WSS 121, from the calculated pre-emphasis amount of the transmission device #2 (110) (step S1411). Subsequently, the optical power control device 1200 transmits the calculated gain and tilt amount of the optical amplifier 123 and the ch ATT values of the WSS 121 to the transmission device #2 (110) (step S1412). As a result, the optical amplifier 123 of the transmission device #2 (110) sets the received gain and tilt amount and the WSS 121 sets the ch ATT values (step S1413), thereby ending the process.

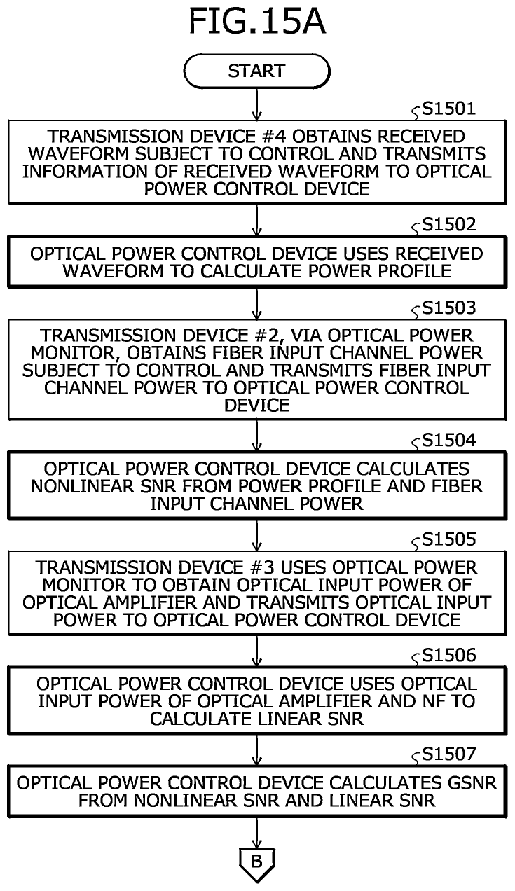

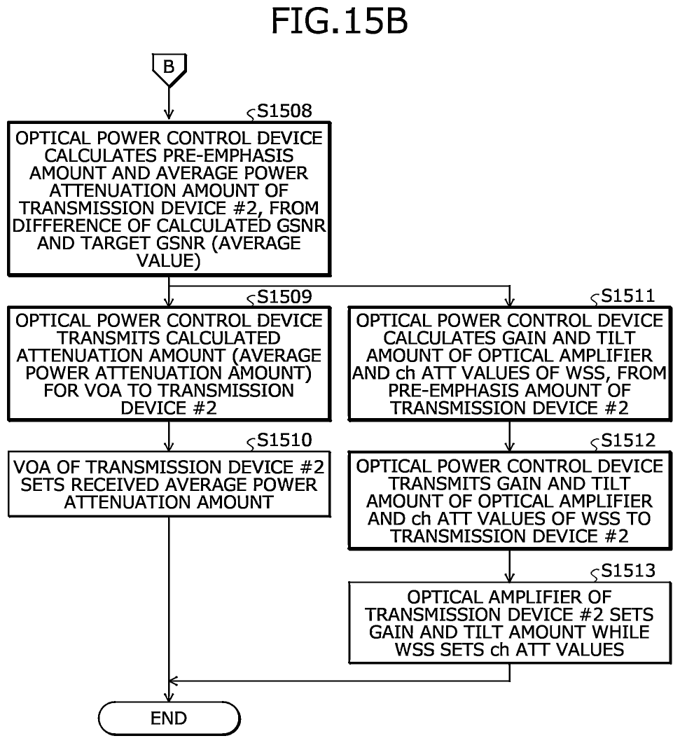

FIGS. 15A and 15B are flowcharts depicting a second GSNR control example according to the optical power control device having the alternative configuration. In the first GSNR control example depicted in FIGS. 14A and 14B, serial (sequential execution) control by the controller 1201 of the optical power control device 1200 is described. In the second GSNR control example depicted in FIGS. 15A and 15B, parallel (parallel execution) control by the controller 1201 of the optical power control device 1200 is described.

Processes at step S1501 to step S1507 in FIG. 15A are the same as the processes at step S1401 to step S1407 in FIG. 14A. First, as depicted in FIG. 15A, the transmission device #4 (110) at the end of the transmission path 130 obtains the received waveform of the wavelength that is subject to control and transmits information of the received waveform to the optical power control device 1200 (step S1501). Subsequently, the optical power control device 1200 (the controller 1201) uses the received waveform to calculate the power profile (step S1502).

Next, the transmission device #2 (110), via the optical power monitor, obtains the fiber input channel power that is subject to control and transmits the fiber input channel power to the optical power control device 1200 (step S1503). Subsequently, the optical power control device 1200 calculates the nonlinear SNR from the received power profile and the fiber input channel power (step S1504).

Next, the transmission device #3 (110) uses the optical power monitor to obtain the optical input power of the optical amplifier and transmits the optical input power to the optical power control device 1200 (step S1505). Subsequently, the optical power control device 1200 uses the optical input power of the optical amplifier and the NF to calculate the linear SNR (step S1506).

Next, the optical power control device 1200 calculates the GSNR from the nonlinear SNR and the linear SNR (step S1507).

Next, as depicted in FIG. 15B, the optical power control device 1200 calculates the pre-emphasis amount and the average power attenuation amount of the transmission device #2 (110), from difference of the calculated GSNR and the target GSNR (average value) (step S1508). As for the processes below, the optical power control device 1200 performs control for the VOA 124 from step S1509 and control for the optical amplifier 123 and the WSS 121 from step S1511, in parallel.

For example, the optical power control device 1200 transmits the calculated attenuation amount (the average power attenuation amount) for the VOA 124 to the transmission device #2 (110) (step S1509). Further, the VOA 124 of the transmission device #2 (110) sets the received average power attenuation amount (step S1510).

Further, in parallel with the process at step S1509, the optical power control device 1200 calculates the gain and tilt amount of the optical amplifier 123 and the ch ATT values of the WSS 121, from the pre-emphasis amount calculated for the transmission device #2 (110) (step S1511). Further, the optical power control device 1200 transmits the calculated gain and tilt amount of the optical amplifier 123 and the ch ATT values of the WSS 121 to the transmission device #2 (110) (step S1512). As a result, the optical amplifier 123 of the transmission device #2 (110) sets the received gain and tilt amount while the WSS 121 sets the ch ATT values (step S1513). With the completion of the processes at step S1510 and step S1513, a series of the processes above is ended.

The optical power control device of the embodiment described above includes the controller that obtains the received waveforms of WDM optical signals transmitted between transmission devices via a transmission path, calculates the power profile of a distance direction of the transmission path based on the received waveforms, and calculates the nonlinear SNR of the transmission path based on the power profile. As a result, the nonlinear SNR may be estimated accurately.

Further, in the optical power control device of the embodiment, the controller may compensate for variation of the calculated nonlinear SNR, calculate a control amount for controlling the input power to the transmission path, and output the calculated control amount to the transmission devices. As a result, the input power of the transmission devices may be suitably controlled based on the accurately estimated nonlinear SNR.

Further, in the optical power control device according to the embodiment, the controller may calculate the linear SNR of the transmission path based on the optical power of the transmission path, calculate variation of the GSNR based on the nonlinear SNR and the linear SNR, and calculate a control amount for compensating for the variation of the GSNR. As a result, the GSNR of each band in multiband transmission may be improved using the accurately estimated nonlinear SNR.

Further, in the optical power control device according to the embodiment, the controller may: calculate the nonlinear effective length based on the power profile of the wavelength that is subject to control; calculate the nonlinear SNR of a desired span subject to control, based on the power profile and the optical amplifier input power detected by the transmission-side transmission device of a pair of transmission devices corresponding to the span; calculate the linear SNR of the span, based on the optical amplifier input power detected by the reception-side transmission device of the pair of transmission devices corresponding to the span subject to control and the noise figure of the optical amplifier; calculate the GSNR based on the nonlinear SNR and the linear SNR; calculate an attenuation amount for each channel of the transmission-side transmission device based on a difference from the target GSNR, which is the control target; and transmit, as a control amount, the attenuation amount for each channel to the transmission-side transmission device. As a result, it is possible to suitably control the optical power between the pair of transmission devices corresponding to the span subject to control and by performing similar optical power control for each span on the transmission path while the optical power may be optimized and the GSNR may be equalized, over all the intervals.

Further, in the optical power control device according to the embodiment, the controller may: calculate the nonlinear effective length based on the power profile of the wavelength that is subject to control; calculate the nonlinear SNR of a span subject to control, based on the power profile and the optical amplifier input power detected by the transmission-side transmission device of the pair of transmission devices corresponding to the span; calculate the linear SNR of the span based on the optical amplifier input power detected by the reception-side transmission device of the pair of transmission devices corresponding to the span subject to control and the noise figure of the optical amplifier; calculate the GSNR based on the nonlinear SNR and the linear SNR; calculate the pre-emphasis amount and the average power attenuation amount for the transmission-side transmission device based on a difference from the target GSNR, which is the control target; from the calculated pre-emphasis amount, calculate the gain and the tilt amount of the optical amplifier of the transmission devices and an attenuation amount for each channel of the WSS; and output, as control amounts, the average power attenuation amount for the VOA of the transmission-side transmission device, the gain and the tilt amount for the optical amplifier, the attenuation amount of each channel for the WSS. As described, control is performed with respect to the WSS, the optical amplifier, and the VOA of the transmission devices; degradation of the NF is suppressed; pre-emphasis control and average power control for each band is performed; optical power between a pair of transmission devices corresponding to a span subject to control may be controlled more suitably; and the same power control is formed for each span in the transmission path, whereby over all the intervals, optical power may be optimized and the GSNR may be equalized.

Further, in the optical power control device according to the embodiment, the controller may: calculate the nonlinear effective length based on the power profile of the wavelength that is subject to control; calculate the input power to the transmission path, based on the optical amplifier input power detected by the transmission-side transmission device of the pair of transmission devices corresponding to a desired span subject to control and the gain and the tilt of the optical amplifier; estimate a reference nonlinear SNR based on values stored in a table according to wavelength, the input power to the transmission path, and stimulated Raman scattering; correct the reference nonlinear SNR based on the nonlinear effective length corresponding to the reference nonlinear SNR and the calculated nonlinear effective length; and thereby, calculate the nonlinear SNR. As described, the nonlinear effective length is calculated based on the power profile of the wavelength that is subject to control, whereby the nonlinear SNR may be estimated accurately.

Further, in the optical power control device according to the embodiment, the controller may obtain the received waveform of an optical signal received by the transmission device at the end of the transmission path and calculate the received power for each predetermined distance based on the received waveform to thereby, calculate the power profile. As a result, the power profile of the transmission path may be easily calculated.

Further, in the optical power control device according to the embodiment, the controller may calculate both a reference power profile based on a design value and a measured power profile based on actual measurements, convert the reference power profile and the measured power profile from logarithmic units to optical power real number units, calculate a reference nonlinear effective length and a measured nonlinear effective length by integrating the optical power for each predetermined distance, and correct variation of the nonlinear SNR based on the reference nonlinear effective length and the measured nonlinear effective length. As described, the reference power profile and the measured power profile are used, whereby variation of the nonlinear SNR may be accurately estimated.

Further, in the optical power control device according to the embodiment, the controller may set the average value of the GSNR in all the wavelengths of the optical signal based on the design value, as the target GSNR. As a result, the nonlinear SNR and the GSNR may be simply and accurately estimated.

Further, in the optical power control device according to the embodiment, the controller may calculate the GSNR of an optical signal actually in operation, based on the nonlinear SNR obtained from the power profile, and may use the calculated GSNR to correct the value of the target GSNR. As a result, instances in which the actual GSNR differs from the design value may be coped with and the nonlinear SNR and the GSNR may be accurately estimated.

Further, in the optical power control device according to the embodiment, the controller may calculate the power profile by coarsely setting the predetermined distance or based on a received waveform for a short distance portion that is from the beginning of the transmission path to a predetermined distance affecting the nonlinear SNR. As a result, obtaining the power profile used in the GSNR control may be expedited and the processing load may be reduced.

Further, the optical transmission system of the embodiment includes transmission devices that are connected to each other via a transmission path and transmit and receive WDM optical signals transmitted via the transmission path, and a controller that obtains a received waveform of a WDM optical signal received by one of the transmission devices, calculates a power profile in the distance direction of the transmission path based on the received waveform, and calculates a nonlinear SNR of the transmission path based on the power profile. Further, the controller controls the input power to the transmission path based on the nonlinear SNR. As a result, the nonlinear SNR of the transmission path of the optical transmission system may be estimated accurately and based on the estimated nonlinear SNR, the input power of each of the transmission devices may be suitably controlled.

Further, in the optical transmission system of the embodiment, the controller may control the input power to the transmission path based on the nonlinear SNR and the linear SNR. As a result, optical power between the transmission devices may be controlled suitably and the optical power over all the intervals may be optimized. Furthermore, the controller may calculate the GSNR based on the nonlinear SNR and the linear SNR and based on the GSNR, may control the input power to the transmission path. As a result, over all the intervals, the power may be optimized and the GSNR may be equalized.

Further, the optical transmission system of the embodiment may include a forward-pumped Raman amplifier that amplifies from a forward direction of the transmission path. Further, the forward-pumped Raman amplifier may include an i-pump and a secondary pump light. As described, even in an instance in which the transmission devices perform forward-pumped Raman amplification, based on the actual power profile, the nonlinear SNR of the transmission path may be accurately estimated without being affected by pump light and the input power of the transmission devices may be suitably controlled.

According to one aspect of the present invention, an effect is achieved in that nonlinear SNR may be accurately estimated.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical power control device, comprising a controller configured to:
obtain a received waveform of a WDM optical signal transmitted between a plurality of transmission devices via a transmission path, and calculate a power profile of a distance direction of the transmission path based on the received waveform; and
calculate a nonlinear SNR of the transmission path based on the power profile.

2. The optical power control device according to claim 1, wherein the controller:
corrects variation of the calculated nonlinear SNR and calculates a control amount for controlling input power to the transmission path, and
outputs the control amount to the plurality of transmission devices.

3. The optical power control device according to claim 1, wherein the controller:
calculates a linear SNR of the transmission path based on optical power of the transmission path,
calculates variation of a generalized SNR (GSNR) based on the nonlinear SNR and the linear SNR, and
calculates a control amount for compensating for variation of the GSNR.

4. The optical power control device according to claim 3, wherein the controller:
calculates a nonlinear effective length based on the power profile of a wavelength that is subject to control,
calculates a nonlinear SNR of a span subject to control, based on the power profile and a first optical amplifier input power of a first optical amplifier, the first optical amplifier input power being detected by a transmission-side transmission device of a pair of the plurality of transmission devices, the pair corresponding to the span subject to control,
calculates a linear SNR of the span based on a noise figure and a second optical amplifier input power of a second optical amplifier, the second optical amplifier input power being detected by a reception-side transmission device of the pair of the plurality of transmission devices,
calculates the GSNR based on the nonlinear SNR and the linear SNR,
calculates an attenuation amount for each channel of the transmission-side transmission device, based on a difference of the calculated GSNR and a target GSNR constituting a control target, and
outputs the attenuation amount for said each channel, as the control amount, to the transmission-side transmission device.

5. The optical power control device according to claim 3, wherein the controller:
calculates a nonlinear effective length based on the power profile of a wavelength that is subject to control,
calculates a nonlinear SNR of a span subject to control, based on the power profile and a first optical amplifier input power of a first optical amplifier, the first optical amplifier input power being detected by a transmission-side transmission device of a pair of the plurality of transmission devices, the pair corresponding to the span subject to control,
calculates a linear SNR of the span based on a noise figure and a second optical amplifier input power of a second optical amplifier, the second optical amplifier input power being detected by a reception-side transmission device of the pair of the plurality of transmission devices,
calculates the GSNR based on the nonlinear SNR and the linear SNR,
calculates a pre-emphasis amount and an average power attenuation amount of the transmission-side transmission device based on a difference of the calculated GSNR and a target GSNR constituting a control target,
calculates, from the calculated pre-emphasis amount, an attenuation amount for each channel of a wavelength selective switch (WSS) and a gain and a tilt amount of the optical amplifier of the plurality of transmission devices, and
outputs the average power attenuation amount for a variable optical attenuator (VOA) of the transmission-side transmission device, the gain and the tilt amount for the optical amplifiers, and the attenuation amount for each channel for the WSS, as the control amount.

6. The optical power control device according to claim 4, wherein the controller:
calculates the nonlinear effective length based on the power profile of the wavelength that is subject to control,
calculates input power to the transmission path based on a gain, a tilt, and the first optical amplifier input power of the first optical amplifier, the first optical amplifier input power being detected by a transmission-side transmission device of a pair of the plurality of transmission devices, the pair corresponding to a desired span subject to control,
estimates a reference nonlinear SNR based on values stored in a table according to wavelength, the input power to the transmission path, and stimulated Raman scattering, and
corrects the reference nonlinear SNR based on the calculated nonlinear effective length and a nonlinear effective length corresponding to the reference nonlinear SNR and thereby calculates the nonlinear SNR.

7. The optical power control device according to claim 6, wherein the controller:
obtains the received waveform of the optical signal received by a terminal one of the plurality of transmission devices at an end of the transmission path, and
calculates received power for each predetermined distance based on the received waveform and thereby calculates the power profile.

8. The optical power control device according to claim 5, wherein the controller:
calculates a reference power profile based on a design value and a measured power profile based on actual measurements,
converts logarithmic units of the reference power profile and the measured power profile into optical power real number units,
calculates a reference nonlinear effective length and a measured nonlinear effective length by integrating optical power of each predetermined distance, and
corrects variation of the nonlinear SNR based on the reference nonlinear effective length and the measured nonlinear effective length.

9. The optical power control device according to claim 4, wherein controller sets, as the target GSNR, an average value of the GSNR over all wavelengths of the optical signal based on a design value.

10. The optical power control device according to claim 4, wherein the controller calculates the GSNR of the optical signal that is in actual operation, based on the nonlinear SNR obtained from the power profile and uses the calculated GSNR to correct a value of the target GSNR.

11. The optical power control device according to claim 7, wherein the controller calculates the power profile by coarsely setting the predetermined distance or based on a received waveform for a short distance portion from a beginning of the transmission path to a predetermined distance affecting the nonlinear SNR.

12. An optical power control method for controlling optical power of a plurality of transmission devices, the optical power control method being executed by a controller and comprising:
obtaining a received waveform of a WDM optical signal transmitted between the plurality of transmission devices via a transmission path;
calculating a power profile of a distance direction of the transmission path based on the received waveform;
calculating a nonlinear SNR of the transmission path based on the power profile.

13. An optical transmission system, comprising:
a plurality of transmission devices connected to one another by a transmission path and transmitting and receiving a WDM optical signal transmitted via the transmission path; and
a controller that obtains a received waveform of the WDM optical signal received by one of the plurality of transmission devices, calculates a power profile of a distance direction of the transmission path based on the received waveform, and calculates a nonlinear SNR of the transmission path based on the power profile.

14. The optical transmission system according to claim 13, wherein the controller controls input power to the transmission path based on the nonlinear SNR.

15. The optical transmission system according to claim 13, wherein the controller controls input power to the transmission path based on the nonlinear SNR and a linear SNR.

16. The optical transmission system according to claim 13, wherein the controller calculates a GSNR based on the nonlinear SNR and a linear SNR and controls input power to the transmission path based on the GSNR.

17. The optical transmission system according to claim 13, further comprising a forward-pumped Raman amplifier that amplifies from a forward direction of the transmission path.

18. The optical transmission system according to claim 17, wherein the forward-pumped Raman amplifier includes an i-pump and a secondary pump light.
